(19) United States
(12) Patent Application Publication
(10) Pub. No.: US 2005/0266874 A1
(43) Pub. Date: Dec. 1, 2005

(54) [METHOD OF AUTOMATICALLY SWITCHING COMMUNICATION MODE]

(76) Inventors: Chengshing Lai, Taipei County (TW); Ping Gu, Nanking (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,736

(22) Filed: May 26, 2004

(51) Int. Cl. H04B 1/38

(52) U.S. Cl. 455/552.1

(57) ABSTRACT

A method of automatically switching a communication mode of a mobile communication device from a first communication system to a second communication system is provided. First, whether the mobile communication device is located within an effective area of the first communication system is detected; wherein when the mobile communication device is located within the effective area of the first communication system, the mobile communication device is set on standby in a communication mode of the first communication system. When the mobile communication device is not located within the effective area of the first communication system, whether the mobile communication device is located within an effective area of the second communication system is detected; wherein when the mobile communication device is located within the effective area of the second communication system, the mobile communication device is set on standby in a communication mode of the second communication system.

### BACKGROUND OF INVENTION

1. Field of the Invention

This invention generally relates to a method of automatically switching the communication mode, and more particularly to a method of automatically switching the communication mode of a mobile communication device from a communication mode of the first communication system to a communication mode of the second communication system.

2. Description of Related Art

In the modern era, new information systems and devices are continuously being developed. People cannot live without electronic communication. It becomes very common for people to communicate with each other via the electronic communication devices, especially the mobile communication devices that can be carried everywhere such as mobile phone or electronic devices with wireless function. The mobile communication devices cannot function without the mobile communication system. The most common mobile communication systems on the market are Group System for Mobile communication (GSM) and Personal Handyphone System (PHS).

Compared to the PHS system, the mobile communication device using GSM system emits stronger radiation, which might affect the human health, especially the human brain. Further, because the power consumption for the GSM system is higher, the standby period for the mobile communication device using the GSM system is shorter. In addition, the communication cost using the GSM system is relatively higher.

Compared to the GSM system, the mobile communication device using PHS system emits weaker radiation. Further, because the power consumption for the PHS system is lower, the standby period for the mobile communication device using the PHS system is longer. In addition, the communication cost using the PHS system is relatively lower.

Although the PHS system has the advantages of low radiation, low power consumption, and low communication cost, it can only operate within a limited area. Therefore, to resolve this drawback, the dual-mode mobile phone which can operates in the GSM and PHS systems is developed.

It should be noted that currently the user has to manually switch the mode of the dual-mode mobile phone in order to use the system. Hence, when the user manually switches the mode of the dual-mode mobile phone to the GSM mode, the communication mode of the dual-mode mobile phone is switched to the GSM mode; when the user manually switches the mode of the dual-mode mobile phone to the PHS mode, the communication mode of the dual-mode mobile phone is switched the PHS mode. In addition, the user can also manually switch the mode of the dual-mode mobile phone to a fully dual-mode; i.e., the communication mode of the dual-mode mobile phone becomes the PHS mode and the GSM mode at the same time.

However, when the user manually switches the mode of the dual-mode mobile phone to a fully dual-mode, the user has to pay communication fees for both GSM and PHS systems. In addition, when the user manually switches the mode of the dual-mode mobile phone to the PHS mode, if the user goes beyond the PHS service area, the user can neither makes a call nor receive the incoming call. Further, when the user manually switches the mode of the dual-mode mobile phone to a fully dual-mode, it will significantly shorten the standby period and the in-use period of the dual-mode mobile phone.

### SUMMARY OF INVENTION

The present invention is directed to a method of automatically switching the communication mode of a dual-mode mobile communication device without operating the manual switch.

According to an embodiment of the present invention, whether the mobile communication device is located within an effective area of the first communication system is detected; when the mobile communication device is detected to be located within the effective area of the first communication system, the mobile communication device is set to a standby in a communication mode of the first communication system; when the mobile communication device is not located within the effective area of the first communication system, whether the mobile communication device is located within an effective area of the second communication system is detected; and when the mobile communication device is located within the effective area of the second communication system, the mobile communication device is set to a standby in a communication mode of the second communication system.

In light of the above, the method of automatically switching the communication mode of the present invention can be applied to a dual-mode mobile communication device. Without operating the manual switch, the communication mode of the mobile communication device can be automatically detected and switches to the mobile communication system at a lower communication cost or a lower power consumption, thereby reducing the communication cost and the power consumption. Further, the possibility of missing calls can be substantially reduced. When the user returns to the original service area, the the mobile communication device is automatically switched to the first mobile communication mode.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is the flow chart for automatically switching the communication mode in accordance with an embodiment of the present invention, wherein the mobile communication device is on standby in the first communication system.

FIG. 2 is the flow chart for automatically switching the communication mode in accordance with an embodiment of the present invention, wherein the mobile communication device is on standby in the second communication system.

FIG. 3 is the flow chart for automatically switching the communication mode in accordance with an embodiment of the present invention, wherein the mobile communication device is on standby without any communication system.

### DETAILED DESCRIPTION

The embodiment of the present invention provides a method of automatically switching a communication mode of a mobile communication device from a first communication system to a second communication system and vice-versa. In this embodiment, the first communication is, for example, the PHS system, and the second communication is, for example, the GSM system. The following description will further illustrate the operation of the mobile communication device in three different standby situations with the accompanied figures.

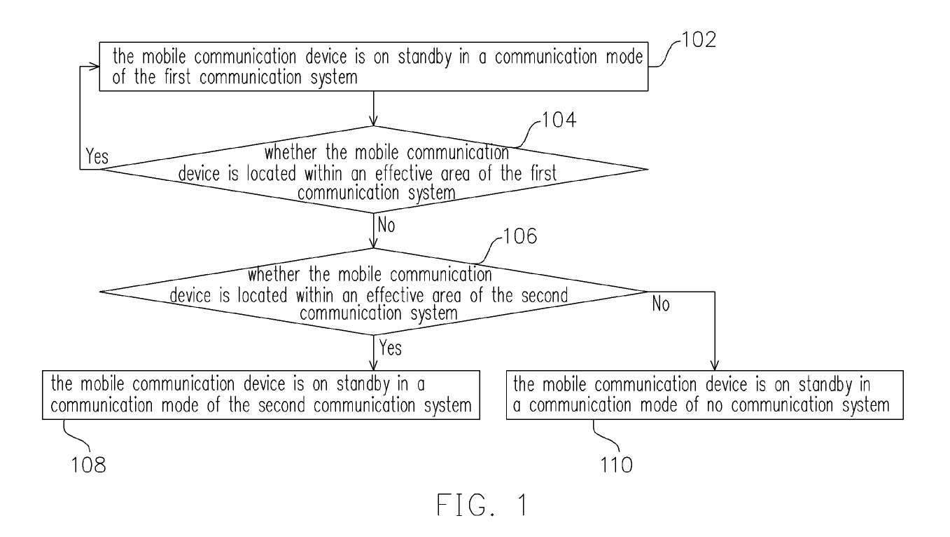

FIG. 1 is a flow chart illustrating a method of automatically switching the communication mode in accordance with an embodiment of the present invention, wherein the mobile communication device is on standby in the first communication system. In step S102, the mobile communication device is on and is on standby in the first communication system. In step S104, whether the mobile communication device is located within an effective area of the first communication system is detected. When the mobile communication device is located within the effective area of the first communication system, the mobile communication device is set on standby in a communication mode of the first communication system as shown in step S102. When the mobile communication device is not located within the effective area of the first communication system, whether the mobile communication device is located within an effective area of the second communication system (S106) is detected. When the mobile communication device is located within the effective area of the second communication system, the mobile communication device is set on standby in a communication mode of the second communication system (S108). When the mobile communication device is not located within the effective area of the second communication system, the mobile communication device is set on standby in a communication mode of no communication system (S110).

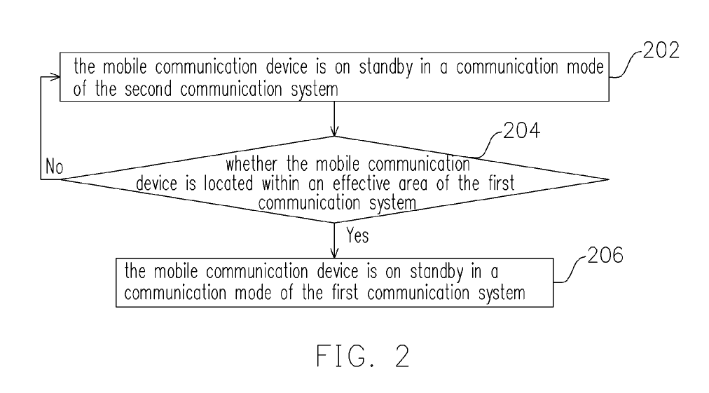

FIG. 2 is a flow chart illustrating a method of automatically switching the communication mode in accordance with an embodiment of the present invention, wherein the mobile communication device is on standby in the second communication system. In step S202, the mobile communication device is on and is on standby in the second communication system. In step S204, whether the mobile communication device is located within an effective area of the first communication system is detected. When the mobile communication device is located within the effective area of the first communication system, the mobile communication device is set on standby in a communication mode of the first communication system (S206). When the mobile communication device is not located within the effective area of the first communication system, the mobile communication device is set on standby in a communication mode of the second communication system (S202).

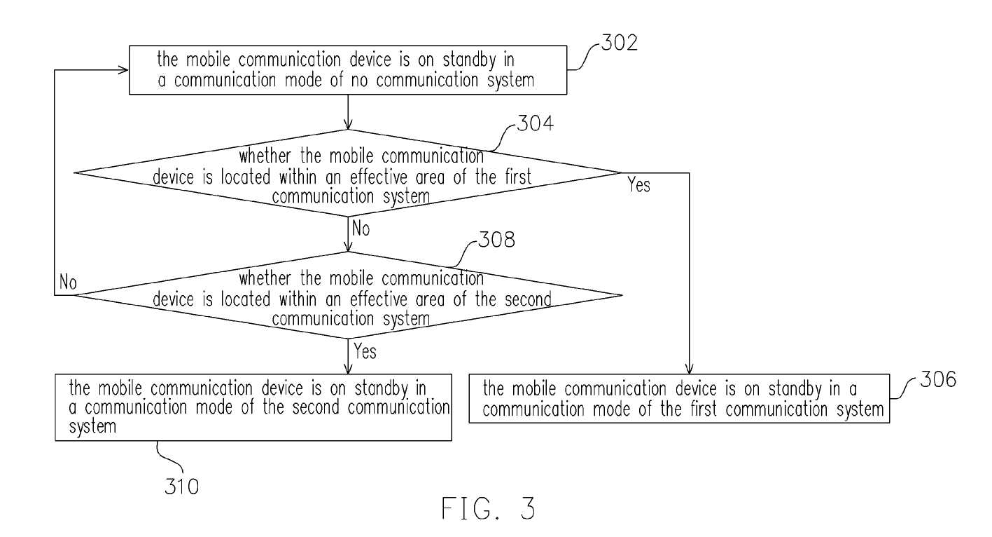

FIG. 3 is a flow chart of automatically switching the communication mode in accordance with an embodiment of the present invention, wherein the mobile communication device is on standby with no communication system. In step S202, the mobile communication device is on and is on standby with no communication system. In step S304, whether the mobile communication device is located within an effective area of the first communication system is detected. When the mobile communication device is located within the effective area of the first communication system, the mobile communication device remain on standby in a communication mode of the first communication system as shown in step S306. When the mobile communication device is not located within the effective area of the first communication system, whether the mobile communication device is located within an effective area of the second communication system (S308) is detected. When the mobile communication device is located within the effective area of the second communication system, the mobile communication device is set on standby in a communication mode of the second communication system (S310). When the mobile communication device is not located within the effective area of the second communication system, the mobile communication device remain on standby in a communication mode of no communication system (S302).

In light of the above, the method of automatically switching the communication mode of the present invention is suitable for a dual-mode or a multi-mode mobile communication device for automatically switching the communication mode to one of several communication systems without operating the manual switch. Therefore, the present invention has at least the following advantages:

1. The communication mode of the mobile communication device can be automatically switched to the available mobile communication system without operating the manual switch, therefore communication cost can be substantially reduced.

2. The communication mode of the mobile communication device can be automatically switched to the available communication system without operating the manual switch, therefore the possibility of missing calls can be reduced.

3. The communication mode of the mobile communication device can be automatically switched to the available communication mode of the mobile communication device, therefore the standby period and the in-use period of the mobile communication device can be extended.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A method of automatically switching a communication mode of a mobile communication device from a first communication system to a second communication system, said method comprising:
detecting whether said mobile communication device is located within an effective area of said first communication system;
wherein when said mobile communication device is located within said effective area of said first communication system, said mobile communication device remain on standby in said communication mode of said first communication system;
detecting whether said mobile communication device is located within an effective area of said second communication system when said mobile communication device is not located within said effective area of said first communication system; and
wherein when said mobile communication device is located within said effective area of said second communication system, said mobile communication device is set on standby in a communication mode of said second communication system.

2. The method of claim 1, further comprising said mobile communication device set on standby in a communication mode of no communication system when said mobile communication device is not located within said effective area of said second communication system.

3. The method of claim 1, wherein said first communication system is a Personal Handyphone System (PHS).

4. The method of claim 1, wherein said first communication system is a Group System for Mobile communication (GSM).

5. The method of claim 1, wherein during said step of detecting whether said mobile communication device is located within said effective area of said first communication system, said mobile communication device is on standby in said communication mode of said first communication system.

6. The method of claim 1, wherein during said step of detecting whether said mobile communication device is located within said effective area of said first communication system, said mobile communication device is on standby in said communication mode of said second communication system.

7. The method of claim 1, wherein during said step of detecting whether said mobile communication device is located within said effective area of said first communication system, said mobile communication device is on standby in said communication mode of no communication system.
